(19) United States
(12) Patent Application Publication
(10) Pub. No.: US 2025/0303752 A1
(43) Pub. Date: Oct. 2, 2025

(54) RECORDING DEVICE

(71) Applicant: SEIKO EPSON CORPORATION, Tokyo (JP)

(72) Inventors: Tatsuya NAKANO, SHIOJIRI-SHI (JP); Takayoshi KOJIMA, AZUMINO-SHI (JP)

(21) Appl. No.: 19/089,459

(22) Filed: Mar. 25, 2025

(30) Foreign Application Priority Data
Mar. 28, 2024 (JP) 2024-053534

(51) Int. Cl. B41J 11/00; B41J 3/407; B41J 25/00; B41J 29/393

(52) U.S. Cl. CPC B41J 11/008; B41J 3/407; B41J 11/0095; B41J 25/005; B41J 29/393; B41J 2029/3935

(57) ABSTRACT

A recording device includes a conveying unit that conveys a medium, a first nozzle group that discharges a first liquid to form a first layer, a second nozzle group that discharges a second liquid after formation of the first layer to form a second layer, a carriage, a detection unit that acquires an error in the conveyance amount of the medium by the conveying unit, and a control unit. A test pattern is formed using the first nozzle group. The detection unit detects the test pattern and acquires an error in the conveyance amount based on a detection position. The control unit adjusts a relative positional relationship between the first layer and the second layer by shifting, in the conveying direction, a nozzle of the second nozzle group which is used and recording the second layer based on the error in the conveyance amount.

The present application is based on, and claims priority from JP Application Serial Number 2024-053534, filed Mar. 28, 2024, the disclosure of which is hereby incorporated by reference herein in its entirety.

### BACKGROUND

### 1. Technical Field

The present disclosure relates to a recording device and, more particularly, to a recording device for recording images of a plurality of layers.

### 2. Related Art

The technique disclosed in JP-A-2011-152688 has been known as a technique for eliminating an error in the conveyance amount of a medium. According to JP-A-2011-152688, while a medium is conveyed by rotating the conveyance roller once, an adjustment pattern is printed on the medium at every predetermined rotation angle, and an error in the conveyance amount is determined based on the adjustment pattern printed on the medium. Then, the conveyance amount is changed based on the correction value reflecting the eccentricity error of the conveyance roller to adjust the deviation of the landing position caused by the conveyance error.

An error to be eliminated by the technique disclosed in JP-A-2011-152688 is an eccentricity error. Since this error depends on the rotation position of the conveyance roller that conveys the medium, in order to adjust the conveyance amount, it is necessary to grasp the rotation position of the conveyance roller at the time of recording in addition to the error obtained on the basis of the test pattern. That is, a sensor that highly senses the rotation position of the conveyance roller is required.

### SUMMARY

The present disclosure is configured to include a conveying unit that conveys a medium in a predetermined conveying direction, a first nozzle group that discharges a first liquid onto the conveyed medium to form a first layer, a second nozzle group that is located downstream of the first nozzle group in the conveying direction of the medium and discharges a second liquid after formation of the first layer to form a second layer, a carriage unit that causes the first nozzle group and the second nozzle group to perform a main scanning operation while crossing the conveying direction of the medium, a detection unit that acquires an error in a conveyance amount of the medium by the conveying unit, and a control unit that controls the conveying unit, the first nozzle group, the second nozzle group, and the carriage unit to form the first layer and the second layer so as to relatively have a predetermined positional relationship, wherein the control unit forms a test pattern at a predetermined position using the first nozzle group, the detection unit detects the test pattern and acquires an error in a conveyance amount of the medium by the conveying unit based on a detection position, and the control unit adjusts a relative positional relationship between the first layer and the second layer by shifting, in the conveying direction, a nozzle of the second nozzle group which is used and recording the second layer based on an error in the conveyance amount.

### BRIEF DESCRIPTION OF THE DRAWINGS

FIG. 1 is a diagram illustrating a schematic configuration of a recording device according to the present disclosure.

FIG. 2 is a diagram illustrating a first layer, a second layer, and an adhesive layer on a medium.

FIG. 3 is a schematic view illustrating the stacking of the first layer and the second layer in a case where nozzle shifting is not performed.

FIG. 4 is a schematic diagram illustrating the stacking of the first layer and the second layer in a case where nozzle shift is not performed when a minus error occurs.

FIG. 5 is a schematic diagram illustrating the stacking of the first layer and the second layer in a case where nozzle shift is performed when a minus error occurs.

FIG. 6 is a schematic view when a sensor of a detection unit is disposed on a platen.

FIG. 7 is a schematic diagram of a test pattern and position detection.

FIG. 8 is a flowchart of a program executed by a control unit.

FIG. 9 is a schematic view when the sensor of the detection unit is disposed on a carriage.

FIG. 10 is a diagram illustrating a modification of a test pattern.

FIG. 11 is a flowchart of a program executed by the control unit.

### DESCRIPTION OF EMBODIMENTS

Below, an embodiment according to the present disclosure will be described with reference to the drawings.

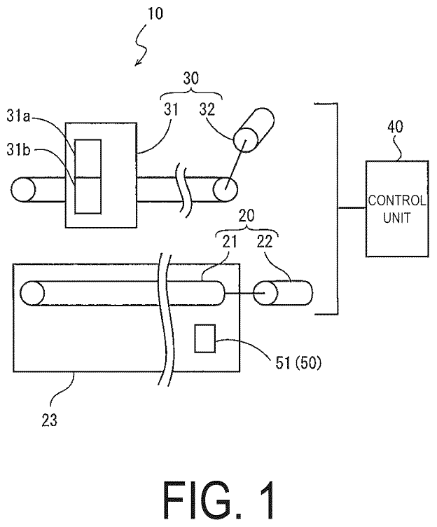

FIG. 1 is a diagram illustrating a schematic configuration of a printing apparatus to which a recording device according to the present disclosure is applied.

A printing apparatus 10 which is a recording device includes a conveying unit 20 including a platen roller 21 and a platen motor 22 which convey a medium in a predetermined conveying direction and a carriage unit 30 including a carriage 31 and a carriage motor 32. The carriage 31 is provided with a first nozzle group 31a for forming a first layer by discharging a first liquid onto a conveyed medium and a second nozzle group 31b for forming a second layer by discharging a second liquid after formation of the first layer, the second nozzle group 31b being located downstream of the first nozzle group 31a in the conveying direction of the medium. The carriage motor 32 causes the carriage 31 to reciprocate in the main scanning direction intersecting the conveying direction of the medium, and the platen motor 22 conveys the medium, thereby printing a predetermined image on the medium.

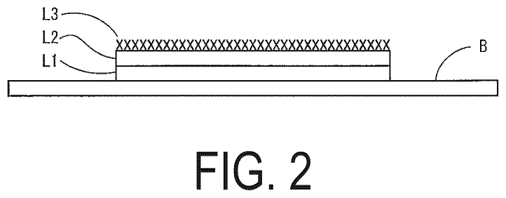

FIG. 2 illustrates a first layer, a second layer, and an adhesive layer on the medium.

After the first nozzle group 31a discharges the first liquid onto a medium B to form a first layer L1, the second nozzle group 31b discharges the second liquid onto the medium B to form a second layer L2 so as to overlap the first layer L1 after formation of the first layer L1. Thereafter, in another step, a powder adhesive layer L3 is formed on the second layer. In this case, generally, the first layer forms an image with color ink, and the second layer forms a background image with white ink. By forming a white ink background with the second layer, the color of the image of the first layer can be prevented from being affected by the color of a cloth.

At the time of use, the adhesive layer L3 is disposed to face a cloth (not shown), heated, and pressed to be transferred, and then the film-like medium B is peeled off to be used.

Returning to FIG. 1, a sensor 51 as a detection unit 50 formed of a CCD camera is disposed at a portion of a platen 23 paired with the platen roller 21 which is located near an end portion of the medium. The sensor 51 detects a test pattern formed at a predetermined position on the medium B using the first nozzle group 31a. Upon detecting the test pattern, the sensor 51 notifies a control unit 40 of the detection.

The control unit 40 controls the conveying unit 20, the first nozzle group 31a, the second nozzle group 31b, and the carriage unit 30 to control printing on the medium B. Furthermore, the control unit 40 forms the first layer and the second layer so as to relatively have a predetermined positional relationship by acquiring the notification of detection of the test pattern from the sensor 51 while forming the test pattern at a predetermined position on the medium B using the first nozzle group 31a. Note that the control unit 40 can acquire an error in the conveyance amount by the conveying unit 20 based on the formation position of the test pattern, the notification from the sensor 51, and the conveyance amount of the medium by the conveying unit 20 therebetween. That is, when the control unit 40 conveys the medium B by the conveying unit 20 after forming the test pattern at the predetermined position using the first nozzle group 31a, the conveyance amount from the position where the test pattern is formed to the position where the sensor 51 is disposed should be always constant. However, in reality, a slight deviation occurs from an originally expected conveyance amount due to a mechanical element or the like. This slight deviation is an error in the conveyance amount, and if there is an error in the conveyance amount, a positional deviation occurs between the first layer and the second layer. This positional deviation is eliminated as follows.

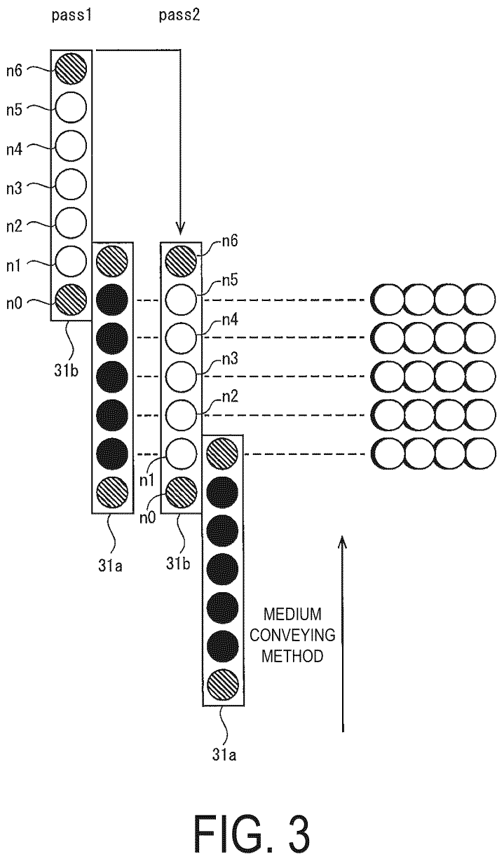

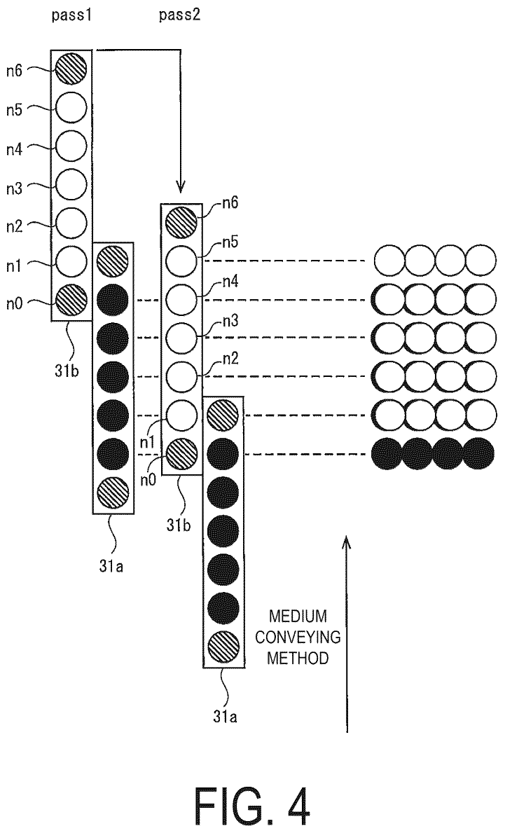

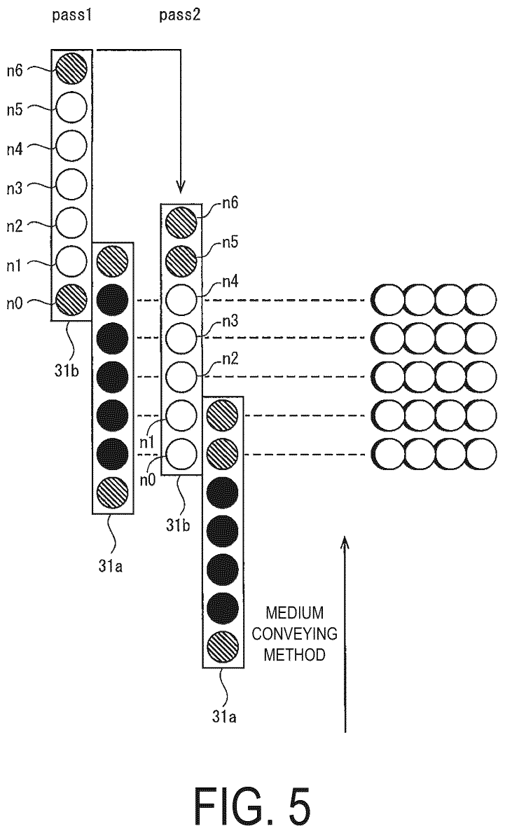

FIGS. 3 to 5 are schematic diagrams illustrating the stacking of the first layer and the second layer. FIG. 3 illustrates a case where the nozzle shift is not performed. FIG. 4 illustrates a case where nozzle shift is not performed when a minus error has occurred. FIG. 5 illustrates a case where nozzle shift is performed when a minus error has occurred. Each drawing illustrates the medium on the assumption that it is conveyed from the bottom to the top of the drawing surface. Therefore, the first nozzle group 31a and the second nozzle group 31b placed on the carriage 31 are illustrated so as to be relatively lowered.

Referring to FIG. 3, the first nozzle group 31a relatively located on the upstream side and the second nozzle group 31b relatively located on the downstream side have a predetermined positional relationship on the carriage 31. This positional relationship is fixed and does not change. In the first nozzle group 31a and the second nozzle group 31b, some nozzles close to the upstream and downstream end portions are used for spare use. In the drawings, it is assumed that nozzles n0 to n6 are provided from the upstream side to the downstream side, and the nozzle no at the upstream end and the nozzle n6 at the downstream end are assigned for spare use. The intermediate nozzles n1 to n5 are assigned for normal use. In the drawings, reference numerals n0 to n6 are attached only to the second nozzle group 31b, but the same reference numerals will be used when referring to the nozzles of the first nozzle group 31a.

After the first layer is formed by the first nozzle group 31a in a first pass pass1 in the main scanning, when the medium B is conveyed by a predetermined amount, the second layer is formed on the first layer by the second nozzle group 31b in a second pass pass2 in the main scanning. If no error occurs in the conveyance amount, the first layer and the second layer are formed in a relatively correct positional relationship without using any nozzle used for the spare use described above. In the present embodiment, the first layer and the second layer are formed at the same position.

FIG. 4 illustrates a case where a minus error has occurred in the conveyance amount. The minus error represents a state in which only a conveyance amount smaller than the assumed conveyance amount can be obtained.

After the first layer is formed by the first nozzle group 31a in the first pass pass1 in the main scanning, the medium B is conveyed, but a minus error has occurred. The second layer is then formed on the first layer by the second nozzle group 31b in the second pass pass2 in the main scanning, but the nozzle position on the most upstream side of the second layer does not reach the nozzle position on the most upstream side of the first layer because the conveyance amount is small. Therefore, all the nozzle positions on the downstream side of the second layer do not reach the nozzle position on the downstream side of the first layer, and the first layer and the second layer are deviated by an error in the conveyance amount that has occurred.

In order to eliminate such a deviation, the control unit 40 executes nozzle shift.

FIG. 5 illustrates a case where nozzle shift is performed when a minus error has occurred in the conveyance amount. In a case where a minus error has occurred, a nozzle assigned for spare use is used.

Originally, when the second liquid is discharged using the intermediate nozzles n1 to n5 in the normal use, the second liquid cannot be discharged onto a pixel row corresponding to one row onto which the first liquid is discharged by the nozzles n5 in the first nozzle group 31a. However, in the case of the nozzle no assigned for spare use to the nozzle n4 for normal use, the second liquid can be discharged onto all the pixel rows onto which the first liquid has been discharged. Therefore, the control unit 40 generates a control signal to the second nozzle group 31b so as to shift the nozzles to be used by one pixel row corresponding to an error in the conveyance amount. Such shifting of the nozzles to be used to the upstream side or the downstream side is called a nozzle shift.

In this manner, by discharging the second liquid using the nozzles n0 to n4 of the second nozzle group 31b, the image of the first layer and the image of the second layer exactly overlap each other. The same also applies to the case of a plus error in which the actual conveyance amount is larger than the assumed conveyance amount. In this case, the second nozzle group 31b moves too far when the medium B is conveyed, and hence the nozzles to be used are shifted to the downstream side. Specifically, when the intermediate nozzle n2 to the spare nozzle n6 are used, the image of the first layer and the image of the second layer exactly overlap each other.

In the present embodiment, the image of the first layer and the image of the second layer exactly overlap each other. However, a nozzle shift is used to maintain the relative positional relationship between the image of the first layer and the image of the second layer, and it is not essential that the image of the first layer and the image of the second layer exactly overlap each other.

Furthermore, the positional relationship between the first nozzle group 31a and the second nozzle group 31b is a positional relationship in which when the medium B is conveyed with respect to the image of the first layer formed by the first nozzle group 31a, the second nozzle group 31b is located on the downstream side in the conveying direction, so that when the second nozzle group 31b discharges the second liquid to form the second layer after formation of the first layer, the image of the second layer is stacked on the image of the first layer.

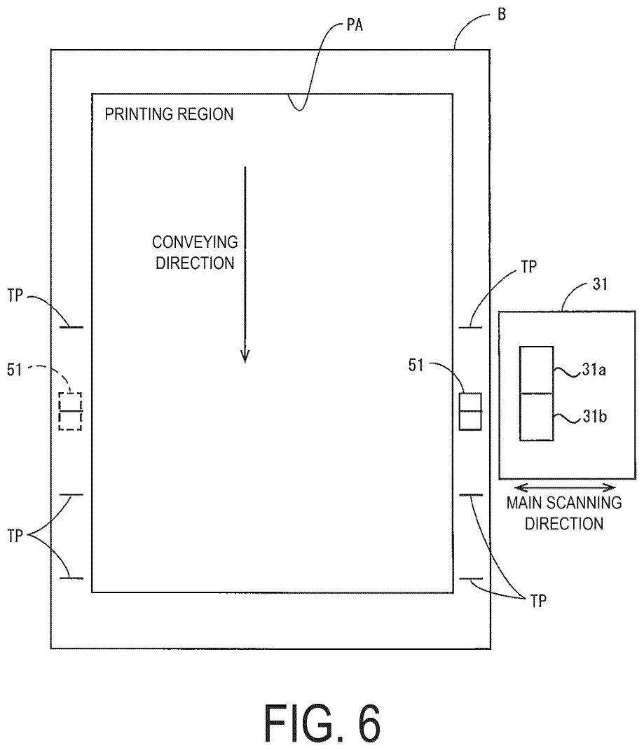

FIG. 6 is a schematic view illustrating a state in which the sensor of the detection unit is disposed on the platen.

The upper, lower, left, and right ends of the medium B in the conveying direction are margins in which printing is not performed, and the inside excluding these margins is a printing region PA. The sensor 51 formed of the CCD camera of the detection unit 50 is placed at a portion corresponding to a margin of the medium B on the platen 23. Referring to FIG. 6, the sensor 51 is disposed at a portion near an end portion.

On the medium B, a region where printing is performed is the printing region PA, and a region where printing is not performed is a margin, and the upper, lower, left, and right ends in the conveying direction are not necessarily margins. In the present embodiment, the control unit 40 causes the first nozzle group 31a to print ruled test patterns TP like those illustrated in the drawing on both left and right ends of the margins.

In this case, since the sensor 51 is supported by the platen 23, if the printing surface of the medium B is defined as the front surface, the sensor 51 faces the back surface opposite to the front surface. However, since the medium B is a transparent film-like medium, even if the sensor 51 faces the back surface of the medium B, it is possible to photograph the test patterns TP formed on the front surface through the medium.

In the present embodiment, the sensor 51 is disposed only in one of the margins at the left and right ends but may be disposed at each of the left and right ends. In this way, for example, even when a printing defect of the test pattern TP occurs at one end, the sensor 51 at the other end can detect the test pattern TP.

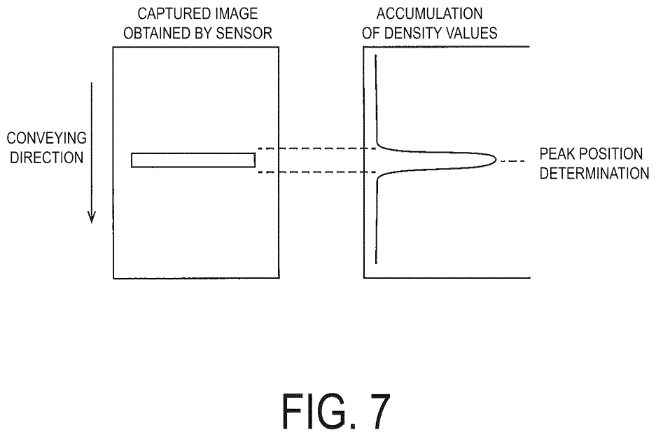

FIG. 7 is a schematic diagram illustrating a test pattern and a state of position detection.

The sensor 51 captures an image of the front surface of the medium B from the back surface of the medium B, and the detection unit 50 determines whether the captured image includes the test pattern TP. Since the captured image is a two-dimensional image as illustrated on the left side of FIG. 7, as illustrated on the right side of FIG. 7, the density values of the pixel columns in a direction orthogonal to the conveying direction are accumulated or averaged, and the representative value is acquired for each column in the conveying direction as the representative value of each pixel column. Subsequently, when an image of the ruled test pattern TP is captured, only the representative value of a specific pixel column exceeds the representative values of the other pixel columns. This pixel column is determined to be the position of the test pattern TP. When the ruled line of the test pattern TP is thicker than the pixel column, the representative values of a plurality of pixel columns exceed the representative values of the other pixel columns. In this case, however, an intermediate point or the point of the peak value of the plurality of pixel columns exceeding the representative values may be determined as the position of the test pattern TP.

Originally, the control unit 40 forms the test pattern TP, and the position thereof is specified. Furthermore, since the control unit 40 instructs the conveying unit 20 to convey by a predetermined amount, the formation position of the test pattern TP can also be accurately predicted. On the other hand, if the detection positions of the actual test pattern TP based on the detection result of the detection unit 50 coincide with each other, the conveyance amount is accurate. However, the conveyance amount may not be accurate due to an external factor such as an error in a machine element or a temperature change, resulting in an error in the conveyance amount.

In order to perform nozzle shift, an error in the conveyance amount is a direct factor, but the detection unit 50 may determine an error in the conveyance amount based on the position where the test pattern TP is detected. Alternatively, the detection unit 50 may notify the control unit 40 of the position of the test pattern, and the control unit 40 may determine an error in the conveyance amount. In this case, the control unit 40 constitutes a part of the detection unit 50.

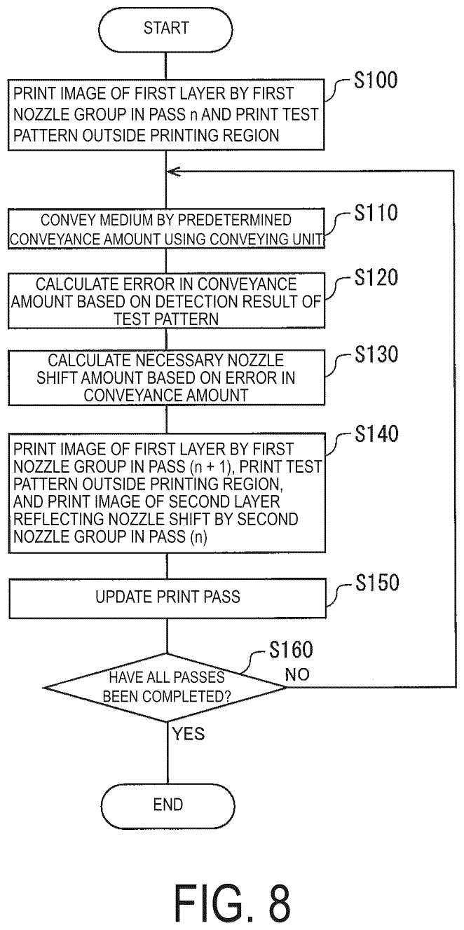

FIG. 8 is a flowchart illustrating a program executed by the control unit.

In step S100, the control unit 40 causes the first nozzle group 31a to print the image of the first layer in a pass (n) in the printing region and to print the test pattern TP outside the printing region PA. The control unit 40 outputs a predetermined drive signal to the first nozzle group 31a while moving the carriage unit 30 in the main scanning direction.

Next, in step S110, the control unit 40 causes the conveying unit 20 to convey the medium B by a predetermined amount. The predetermined amount is, for example, the amount of conveyance from the formation of the first layer by the first nozzle group 31a to the formation of the second layer on the first layer by the second nozzle group 31b when stacking the image of the second layer on the image of the first layer. That is, it can also be rephrased as the amount of conveyance when the second layer is stacked with the nozzles of the second nozzle group 31b on the test pattern recorded outside the printing region PA by the first nozzle group 31a. The conveyance amount is specified by the control unit 40 by a control signal to the carriage motor 32.

In step S120, the control unit 40 acquires an error in the conveyance amount based on the detection result of the test pattern TP by the sensor 51. As described above, the detection unit 50 may determine an error in the conveyance amount, or the control unit 40 may calculate and obtain an error in the conveyance amount based on the detection position of the test pattern. Then, in step S130, the control unit 40 calculates a necessary nozzle shift amount based on the error in the conveyance amount.

After the pass (n), for example, in the next pass (n+1), the second layer is formed on the first layer formed in the previous pass (n), and the first layer in the next pass (n+1) is formed. Therefore, in step S140, the control unit 40 causes the first nozzle group 31a to print an image of the first layer in the printing region PA in the next pass (n+1) and to print the test pattern TP outside the printing region PA and further causes the second nozzle group 31b to print an image of the second layer reflecting the nozzle shift so as to correspond to the conveyance amount between the previous pass (n) and the next pass (n+1). The control unit 40 controls the first nozzle group 31a and the second nozzle group 31b while driving the carriage unit 30 in the main scanning direction by the carriage 31.

Printing the image of the second layer while reflecting the nozzle shift will stack the first layer and the second layer at relatively accurate positions regardless of an error in the conveyance amount.

In step S150, the control unit 40 updates the print pass to the next pass. In step S160, the control unit 40 determines whether all the passes have been completed. If all the passes have not been ended, the process returns to step S110 to repeat the subsequent processing. If all the paths have been ended, the processing is ended.

In this manner, the detection unit 50 acquires an error in the conveyance amount after forming the first layer and shifts the nozzle range for forming the second layer according to the error, so that it is not necessary to grasp the absolute position of the medium B as in JP-A-2011-152688. In order to improve the accuracy of sensing for grasping an absolute position, an expensive device must be used. On the other hand, it is relatively easy to detect the position of the test pattern after conveyance while forming the test pattern in each pass, and it is possible to accurately stack the first layer and the second layer or prevent deviation from a predetermined positional relationship.

When the first layer is formed in a plurality of passes, the medium is conveyed between the respective passes forming the first layer, and hence an error may occur in each pass. Therefore, the conveyance amount corresponding to each conveyance may be acquired, and nozzle shift may be executed according to the error.

For example, when the first layer and the second layer are formed in two passes, an image of the second layer reflecting the nozzle shift is printed as follows. First, printing of the first pass for forming the first layer is executed. Thereafter, the medium is conveyed by a predetermined amount, and then printing in the second pass for forming the first layer is executed. Thereafter, an error in the conveyance amount from the printing in the first pass for the first layer is calculated after the medium is conveyed by a predetermined amount, and printing reflecting the nozzle shift is executed based on the error in the conveyance amount from the printing in the first pass for the first layer in the first pass for the second layer. Thereafter, an error in the conveyance amount from the printing in the second pass for the first layer is calculated after the medium is conveyed by a predetermined amount, and printing reflecting the nozzle shift is executed based on the error in the conveyance amount from the printing in the second pass for the first layer in the second pass for the second layer.

That is, when the first layer is printed in a plurality of passes, the second layer is printed while reflecting the nozzle shift in each pass according to the number of passes for the first layer.

As a result, the first layer and the second layer can be accurately stacked on each other even when the first layer is formed in a plurality of passes.

In the above-described embodiment, since the medium B is in the form of a transparent film, the sensor 51 is placed on the platen 23 side, and an image of the test pattern TP on the surface of the medium B can be captured. On the other hand, when the medium B is not in the form of a transparent film, a sensor may be disposed on a side of the carriage 31 facing the surface.

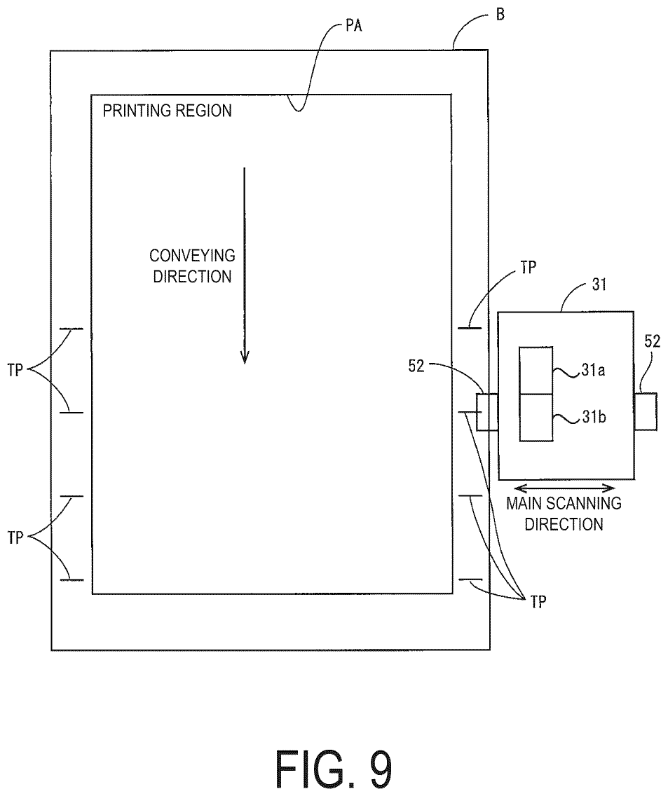

FIG. 9 is a schematic view illustrating a state in which the sensor of the detection unit is disposed on the carriage.

As illustrated in FIG. 9, sensors 52, 52 are arranged at both ends of the carriage 31 with reference to the main scanning direction, on which the first nozzle group 31a and the second nozzle group 31b are placed. An image of the formation region of the test pattern TP is captured, and the formation position of the test pattern TP is specified in either case where the sensor 51 is placed on the platen 23 or the sensor 52 is placed on the carriage 31. The formation position of the test pattern TP may be one or both of the positions outside the printing region.

In this case, the sensor 52 may be fixed to at least the second nozzle group 31b. For example, if the first nozzle group 31a and the second nozzle group 31b are arranged in separate carriages 31, the sensor 52 may move in the main scanning direction together with the second nozzle group 31b.

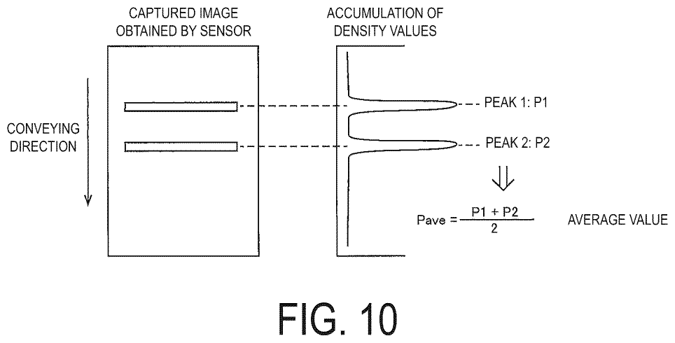

FIG. 10 is a schematic diagram illustrating a modification of the test pattern.

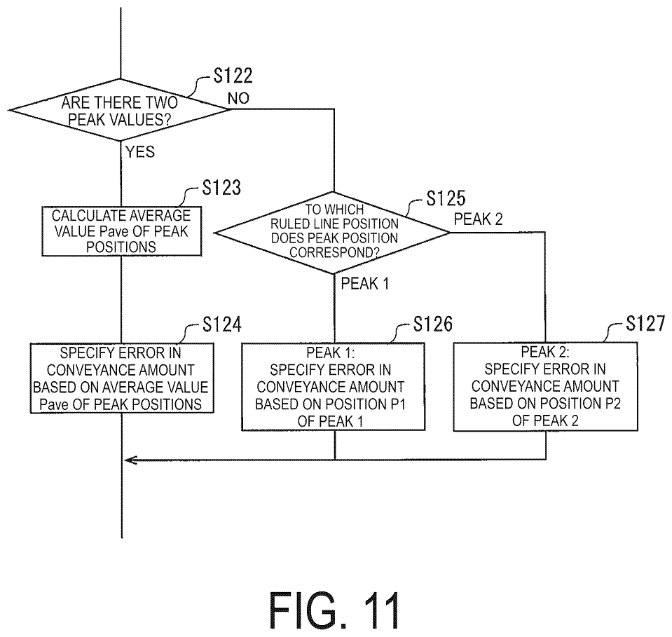

In the above-described embodiment, the test pattern TP has a single ruled line shape, but the shape of the test pattern TP can be appropriately changed and may be, for example, two ruled lines as illustrated in FIG. 11. In the case of two ruled lines, two peak positions P1 and P2 corresponding to the respective ruled line positions are specified when the density value is set as a representative value on the basis of the captured image.

When the number of ruled lines is one, if nozzle clogging occurs when a ruled line is printed using a predetermined nozzle of the first nozzle group 31a, there is a possibility that the ruled line becomes blurred or cannot be printed. On the other hand, when there are two ruled lines, there is an advantage that even if the nozzle corresponding to one ruled line is clogged, the other ruled line can be printed. That is, it is possible to secure robustness such as detection stability.

However, different processes are required for the case of one ruled line and the case of two ruled lines.

FIG. 11 is a flowchart illustrating a program executed by the control unit. This processing is executed as alternative processing of step S120 described above.

In step S122, the control unit 40 determines whether there are two peak values. In a case where there are two peak values, an average value Pave of the peak positions is obtained in step S123. In step S124, an error in the conveyance amount is specified based on the average value Pave of the peak positions. Since the average value Pave of the peak positions represents the intermediate position of the ruled lines, this position is used as the representative value of the test pattern.

On the other hand, when one ruled line cannot be specified due to blurring or the like and only one ruled line is detected, it is determined in step S125 which ruled line position the peak position corresponds. An error in the conveyance amount is not as large as the ruled line interval of the test pattern TP. Therefore, the position where the test pattern TP is detected can be predicted. If the predicted position of the intermediate position between the two ruled lines can be specified, it can be determined which one of the detected peak values corresponds to which ruled line position.

On the basis of the result, when it corresponds to peak 1, the control unit 40 determines peak 1 and specifies the error in the conveyance amount based on the position P1 of peak 1 in step S126, whereas when it corresponds to peak 2, the control unit 40 determines peak 2 and specifies the error in the conveyance amount based on the position P2 of peak 2 in step S127.

The other processing is executed in the same manner as the above-described processing.

Note that it is needless to say that the present disclosure is not limited to the embodiment described above. It is obvious for those skilled in the art that:
mutually replaceable members, configurations, and the like disclosed in the embodiment described above can be applied by appropriately changing their combinations;
although not disclosed in the embodiment, known members, known configurations, and the like that are mutually replaceable with the members, configurations, and the like disclosed in the embodiment are appropriately replaced, and also combinations thereof are changed and applied; and
although not disclosed in the embodiment, the members, the configurations, and the like disclosed in the embodiment described above are appropriately replaced, as a replacement, with members, configurations, and the like that those skilled in the art could conceive on the basis of know techniques or the like, and also combinations thereof are changed and applied. These should be disclosed as embodiments of the present disclosure.

What is claimed is:

1. A recording device comprising:
a conveying unit that conveys a medium in a predetermined conveying direction;
a first nozzle group that discharges a first liquid onto the conveyed medium to form a first layer;
a second nozzle group that is located downstream of the first nozzle group in the conveying direction of the medium and discharges a second liquid after formation of the first layer to form a second layer;
a carriage unit that causes the first nozzle group and the second nozzle group to perform a main scanning operation while crossing the conveying direction of the medium;
a detection unit that acquires an error in a conveyance amount of the medium by the conveying unit; and
a control unit that controls the conveying unit, the first nozzle group, the second nozzle group, and the carriage unit to form the first layer and the second layer so as to relatively have a predetermined positional relationship, wherein
the control unit forms a test pattern at a predetermined position using the first nozzle group,
the detection unit detects the test pattern and acquires an error in a conveyance amount of the medium by the conveying unit based on a detection position, and
the control unit adjusts a relative positional relationship between the first layer and the second layer by shifting, in the conveying direction, a nozzle of the second nozzle group which is used and recording the second layer based on an error in the conveyance amount.

2. The recording device according to claim 1, wherein the medium is a transparent medium, and the detection unit includes a sensor that is provided on a platen at which the medium is placed and detects the test pattern transmitted through the transparent medium.

3. The recording device according to claim 1, wherein the detection unit includes a sensor that is disposed movably in a main scanning direction in a state of facing the medium together with the second nozzle group and detects the test pattern.

4. The recording device according to claim 1, wherein the test pattern is a plurality of ruled lines.
